(19) United States
(12) Patent Application Publication
(10) Pub. No.: US 2026/0045575 A1
(43) Pub. Date: Feb. 12, 2026

(54) BATTERY MODULE WITH EMBEDDED HEATING CAPABILITY

(71) Applicant: MOXION POWER CO., Mill Valley, CA (US)

(72) Inventors: Edward Yankoski, West Branch, MI (US); Alexander J. Smith, Lakeside, CA (US)

(21) Appl. No.: 19/364,324

(22) Filed: Oct. 21, 2025

Related U.S. Application Data
(63) Continuation of application No. PCT/US2024/025704, filed on Apr. 22, 2024.
(60) Provisional application No. 63/497,628, filed on Apr. 21, 2023.

(51) Int. Cl. H01M 10/615; H01M 10/637; H01M 10/6571

(52) U.S. Cl. CPC H01M 10/615; H01M 10/637; H01M 10/6571; H01M 2200/106; H01M 2220/10

(57) ABSTRACT

A battery temperature controlling apparatus and system are disclosed. The apparatus and system can include two or more conductor assemblies disposed on at least two different sides of a plurality of battery cells. Each conductor assembly can include an embedded heating element. Through the two or more conductor assemblies, heat may be provided to the plurality of battery cells through two or more sides.

### CROSS-REFERENCE TO RELATED APPLICATIONS

This application is a continuation of International Application No. PCT/US2024/025704 filed April 22, 2024, which claims priority to U.S. Provisional Patent Application No. 63/497,628, filed April 21, 2023, and titled “BATTERY MODULE WITH EMBEDDED HEATING CAPABILITY”, the complete disclosures of which are incorporated herein by reference for all purposes.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present application relates generally to all-electric, portable industrial power generators which provide temporary on-site power to industries such as construction, film, entertainment, power and utility, electric vehicles, and telecom. More specifically, this disclosure provides a battery module for use with portable power generators that include an embedded heating capability.

### BACKGROUND

Temporary electrical power systems are typically used in scenarios in which access to the electrical grid does not exist at a particular site or when the existing electrical grid does not satisfy the power requirements of the site. Examples include construction sites, mining sites, manufacturing sites, shipping locations, areas impacted by natural disasters, temporary event locations, electric vehicle charging, and others (e.g., such as military installations, telecom sites, and residential locations).

All-electric, portable industrial power generators may be used to provide temporary electrical power in cases when traditional internal combustion generators are not desired or cannot be used due to site specific or user specific requirements. The all-electric industrial power generators may rely on a plurality of batteries to provide stored energy that may be converted into alternating current (AC) power on demand. Some batteries may become less efficient as ambient temperatures drop. It is desirous to have a space-efficient, battery thermal management solutions for use with the industrial equipment, including all-electric industrial power generators.

### SUMMARY OF THE DISCLOSURE

Described herein are apparatuses, systems, and methods to control temperatures of battery cells, particularly battery cells for use with mobile power units designed to provide alternating current power at job sites, construction zones, temporary facilities, disaster relief ,or the like.

Any of the apparatuses described herein may include a battery housing that includes at least two conductor assemblies. Each conductor assembly can include a current collector and an embedded heating element assembly. In general, the embedded heating element assemblies can provide heat in at least two separate places or regions with respect to batteries within the battery housing. The heat can increase battery operating efficiencies, particularly when the batteries are operating at low temperatures. In some embodiments, the heat can pre-condition the batteries for rapid charging.

Any of the apparatuses described herein can include a battery housing. The battery housing can include a first conductor assembly disposed proximate to a first side of a plurality of battery cells, and a second conductor assembly disposed proximate to a second side of the plurality of battery cells. The first conductor assembly can include a first current collector configured to electrically couple together two or more battery terminals on the first side of the plurality of battery cells and a first embedded heating element assembly configured to deliver heat to the first side of the plurality of battery cells. The second conductor assembly can include a second current collector configured to electrically couple together two or more battery terminals on the second side of the plurality of battery cells and a second embedded heating element assembly configured to deliver heat to the second side of the battery cell.

In any of the apparatuses, the first embedded heating element and the second embedded heating element can include a positive temperature coefficient (PTC) heating element. In some variations, the PTC heating element can include at least one of a PTC ink and a PTC foil. In some other variations, wherein the PTC heating element can regulate an operating or ambient temperature of at least one of the first embedded heating element and the second embedded heating element.

In any of the apparatuses described herein, the first embedded heating element and the second embedded heating element can include a resistive layer configured to radiate heat. In some variations, the first embedded heating element and the second embedded heating element can be configured to be powered by one or more of the battery cells. In general, the first embedded heating element can be disposed on a first substrate separate from the first current collector and the second embedded heating element can be disposed a on a second substate separate from the second current collector. In any of the apparatuses, the first embedded heating element can be disposed between the battery cells and the first current collector, and the second embedded heating element can be disposed between the battery cells and the second current collector.

In any of the apparatuses, the first embedded heating element assembly can be further disposed adjacent to a first axial end of the plurality of battery cells and the second embedded heating element assembly can be further disposed adjacent to a second axial end of the plurality of battery cells.

In some embodiments, the first embedded heating element and the second embedded heating element can be operated in response to a temperature near at least one of the first embedded heating element and the second embedded heating element. In some cases, the first embedded heating element can include a temperature sensor configured to determine a temperature near the first embedded heating element. In this manner, temperature can be regulated based on a sensed temperature.

In any of the apparatuses described herein, the first embedded heating element and the second embedded heating element can be configured to operate in response to an enable signal. In any of the apparatuses, the first side of the plurality of battery cells can be opposite to and across from the second side of the plurality of battery cells.

Some of the apparatuses may include a controller configured to operate the first embedded heating element and the second embedded heating element in response to a temperature near at least one of the first embedded heating element and the second embedded heating element.

Any of the apparatuses described herein may include a battery temperature control system. The battery temperature control system may include a battery housing, and a controller. The battery housing can include a first conductor assembly and a second conductor assembly. The first conductor assembly can be disposed proximate to a first side of a plurality of battery cells and include a first current collector configured to electrically couple together two or more battery terminals on the first side of the plurality of battery cells and a first embedded heating element assembly configured to deliver heat to the first side of the plurality of battery cells. The second conductor assembly can be disposed proximate to a second side of the plurality of battery cells and include a second current collector configured to electrically couple together two or more battery terminals on the second side of the plurality of battery cells and a second embedded heating element assembly configured to deliver heat to the second side of the battery cells. The controller can be configured to operate the first embedded heating element and the second embedded heating element based at least in part on a temperature near at least one of the first embedded heating element and the second embedded heating element.

In any of the apparatuses, the first embedded heating element can include a temperature sensor configured to determine a temperature near the first embedded heating element.

In any of the apparatuses described herein, the first embedded heating element and the second embedded heating element can include a positive temperature coefficient (PTC) heating element. In some variations, the PTC heating element can include at least one of a PTC ink and a PTC foil. In some other variations, the PTC heating element can regulate an operating temperature of at least one of the first embedded heating element and the second embedded heating element.

In any of the apparatuses, the first embedded heating element can be disposed between the battery cells and the first current collector, and the second embedded heating element can be disposed between the battery cells and the second current collector. In some embodiments, the first embedded heating element and the second embedded heating element can be configured to be powered by one or more of the battery cells.

In general, the first embedded heating element and the second embedded heating element can include a resistive layer configured to radiate heat. In some examples, the first embedded heating element is disposed on a first substrate separate from the first current collector and the second embedded heating element is disposed a on a second substate separate from the second current collector.

In any of the apparatuses described herein, the first embedded heating element assembly can be further disposed adjacent to a first axial end of the plurality of battery cells and the second embedded heating element assembly can be further disposed adjacent to a second axial end of the plurality of battery cells.

In any of the apparatuses, the first embedded heating element and the second embedded heating element can be configured to operate in response to an enable signal. In some variations, the controller can be further configured to generate the enable signal.

In one aspect, an all-electric mobile power unit is provided, comprising: an external mobile power unit housing; a plurality of battery housing disposed within the external mobile power unit housing, each battery housing comprising: a first conductor assembly disposed proximate to a first side of a plurality of battery cells, the first conductor assembly comprising: a first current collector configured to electrically couple together two or more battery terminals on the first side of the plurality of battery cells; and a first embedded heating element configured to deliver heat to the first side of the plurality of battery cells; and a second conductor assembly disposed proximate to a second side of the plurality of battery cells, the second conductor assembly including: a second current collector configured to electrically couple together two or more battery terminals on the second side of the plurality of battery cells; and a second embedded heating element configured to deliver heat to the second side of the battery cells; and a controller configured to operate the first embedded heating element and the second embedded heating element of each battery housing based at least in part on a temperature near at least one of the first embedded heating element and the second embedded heating element.

In some aspects, the first embedded heating element includes a temperature sensor configured to determine a temperature near the first embedded heating element.

In one aspect, the first embedded heating element and the second embedded heating element include a positive temperature coefficient (PTC) heating element.

In some aspects, the PTC heating element comprises at least one of a PTC ink and a PTC foil.

In other aspects, the PTC heating element regulates an operating temperature of at least one of the first embedded heating element and the second embedded heating element.

In one aspect, the first embedded heating element is disposed between the battery cells and the first current collector, and the second embedded heating element is disposed between the battery cells and the second current collector.

In some aspects, the first embedded heating element and the second embedded heating element are configured to be powered by one or more of the battery cells.

In one aspect, the first embedded heating element and the second embedded heating element include a resistive layer configured to radiate heat.

In some aspects, the first embedded heating element is disposed on a first substrate separate from the first current collector and the second embedded heating element is disposed a on a second substate separate from the second current collector.

In other aspects, the first embedded heating element is further disposed adjacent to a first axial end of the plurality of battery cells and the second embedded heating element is further disposed adjacent to a second axial end of the plurality of battery cells.

In one aspect, the first embedded heating element and the second embedded heating element are configured to operate in response to an enable signal.

In some aspects, the controller is further configured to generate the enable signal.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a view of an example mobile power unit.

FIG. 2 is an example block diagram illustrating the various components and electrical connections within a mobile power unit.

FIG. 3 shows an isometric view of an example battery housing. .

FIG. 4 is simplified block diagram of a battery temperature control system.

FIG. 5 shows an example cross-sectional view of a battery system.

FIG. 6 depicts an example conductor assembly .

FIG. 7 is a detailed view of an example embedded heating element assembly.

FIG. 8 is a block diagram of an example battery temperature control system.

### DETAILED DESCRIPTION

In general, all-electric, portable, industrial power generators include one or more battery cells to provide stored energy that may be converted into electrical AC or DC power. The industrial power generator may use several battery cells to supply sufficient electrical capacity and/or voltage for any DC/DC converters, power inverters, or any other associated circuitry. The battery cells themselves can be removably mounted or affixed into a receiving frame within the industrial power generators.

Battery efficiency may be adversely affected by environmental temperatures of the battery cells. For example, as temperatures decrease, the battery cells may deliver less power (voltage/current). To increase battery efficiency, two or more embedded heating elements can be used to increase temperatures around the battery cells. In some cases, the temperature of the battery may be increased to help reduce charging times. Elevated battery temperatures can condition the battery cells to recharge faster than at lower temperatures. In some implementations, heating elements can prevent battery temperatures from dropping below a temperature, such as a minimum operating temperature.

The present disclosure is related to apparatuses and systems that solve technical problems related to controlling battery temperature. Although described herein in the context of portable, industrial power generators, the apparatuses described herein can be used with any feasible device or application where controlling the temperature of battery cells is desired.

A battery module or housing is disclosed that can include embedded heating capability included within two or more conductor assemblies. Each conductor assembly can include a current collector and an embedded heating element. Each conductor assembly can be disposed near one side of any feasible battery cells. The embedded heating elements can deliver heat to two sides of the battery cells more quickly than conventional single heating element systems. The embedded heating elements may also use less power, especially when they are disposed adjacent to the battery cells. In some embodiments, the embedded heating elements can include multi-layer embedded resistive traces.

Any of the example conductor assemblies can provide advantages compared to conventional heating assemblies. In some cases, the disclosed assemblies can remove the need for additional external heating elements, provide reduced thermal system power requirements, and reduce or simplify associated wiring harnesses. In some variations, the disclosed assemblies can reduce manufacturing assembly steps, reduce parts count, and integrate with a battery bus (current collector), thereby mitigating the need for a separate thermal system. In some instances, external thermal systems can be removed completely.

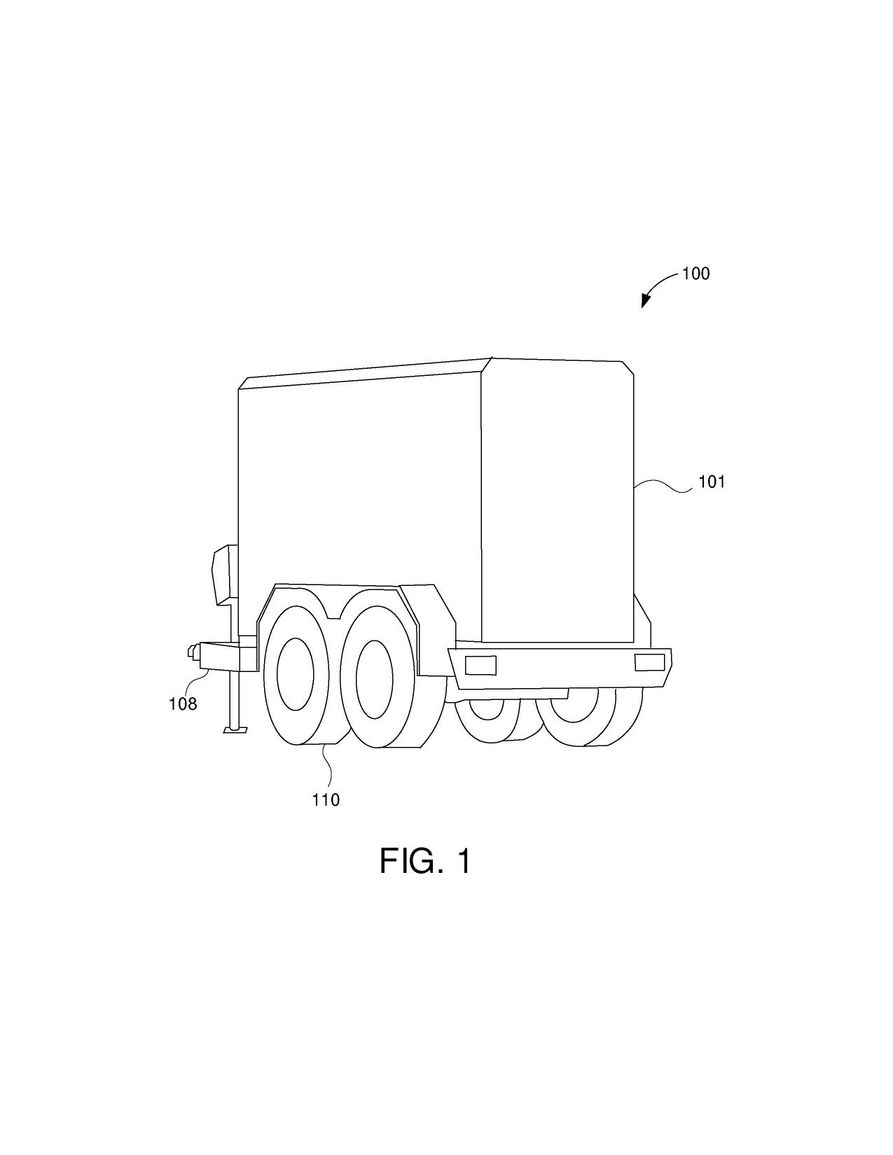

FIG. 1 is a view of an example mobile power unit 100. The mobile power unit 100 may be an all-electric or hybrid power unit configured to provide alternating current (AC) and/or direct current (DC) power on demand for any feasible use. In some embodiments, the desired electrical output is chosen by the user from a pre-selected group of common electrical outputs (e.g., 480VAC 3-Phase, 208VAC 3-Phase, 240VAC 1-Phase, 120VAC 1-Phase or the like). In another embodiment, the user can select any desired output voltage amplitude, frequency, and phase shift, allowing the mobile power unit to provide any user-selected electrical output. The mobile power unit 100 can further be configured to provide a regulated DC output (e.g., for electric vehicle charging). In some embodiments, the mobile power unit 100 may be controlled through an integrated control panel or through a GUI implemented on a remote device, such as a smartphone, tablet, or PC, which can be configured to communicate with the mobile power unit via wireless technologies such as Bluetooth, Wi-Fi, cellular, etc.

The mobile power unit 100 can include an electrical energy source (not shown) disposed within a housing 101. In one configuration, the electrical energy source comprises a plurality of lithium-ion battery cell groups arranged in series connections. In some examples, a plurality of cells are arranged within modular battery housings, and a plurality of these modular battery housings are disposed within housing 101 of the mobile power unit. In other embodiments, the electrical energy source can comprise other known energy storage devices, such as ultracapacitors or fuel cells. While lithium-ion is presently the preferred battery cell type, it should be understood that other battery cells can be used in place of lithium-ion cells as battery technology evolves. In some examples, the electrical energy source can have an operating voltage range of 300-450 volts. In other embodiments, the electrical energy source can have a higher operating voltage range of 450-1000 volts.

The mobile power unit 100 can include a trailer 108 configured to attach to a trailer hitch or tow vehicle, and a plurality of wheels 110 which allow for ease of transportation and delivery of the mobile power unit to remote sites. The size of the mobile power unit 100 can vary depending on electrical output and energy storage capabilities, but in general, the mobile power unit 100 itself can range in size from approximately 50” long, 30” wide, and 50” tall up to 150” long, 60” wide, and 60” tall. The trailer can add an extra 50-70” in length and 20-30” in height depending on the size and weight of the mobile power unit 100 and the number and size of wheels required to carry the weight of the mobile power unit 100. In a preferred embodiment, the mobile power unit 100 is approximately 100” long,40” wide, and 60” tall, with the trailer adding an additional 40-50” in length and 15-30” in height. In other embodiments, the mobile power unit can be scaled up or down in terms of operating voltage range and outputs, and the size of the mobile power unit 100 can be adjusted accordingly.

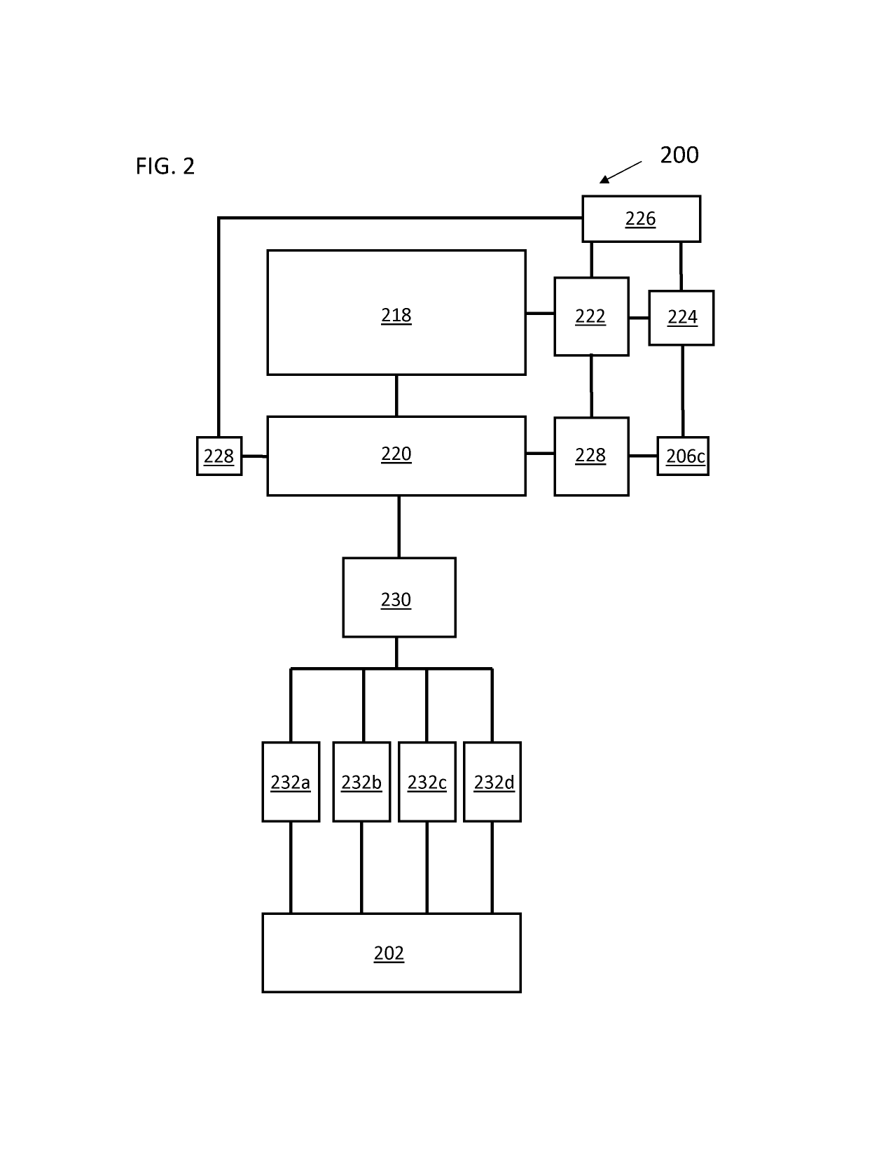

FIG. 2 is an example block diagram illustrating the various components and electrical connections within a mobile power unit 200. The mobile power unit 200 may be an example of the mobile power unit 100 of FIG. 1. The mobile power unit 200 can include an electrical energy source 218 which can comprise, for example, a plurality of battery cells as described above. The electrical energy source 218 can be electrically connected to a power distribution unit (PDU) 220, which includes a plurality of electrical inputs and outputs configured to distribute electrical power throughout the mobile power unit 200. The PDU 220 can be in a centralized location within the mobile power unit 200 for connection/disconnection/fusing of multiple electrical components.

Battery management can be controlled with a battery management system (BMS) 222. The BMS 222 is configured to monitor the state of every battery cell group and can measure any number of battery parameters, including voltage, temperature, current, etc. The BMS 222 is further configured to protect against under and over voltage, measure resistance, estimate charge state, estimate the state of health, and measure power limits of each battery cell group. Additionally, the BMS 222 can be configured to monitor high voltage isolation resistance between the high voltage DC components (such as the electrical energy source 218, the BMS 222, the PDU 220, etc.) and a chassis of the mobile power unit to ensure that this isolation resistance is above acceptable thresholds. In the event of an isolation fault, the BMS 222 can be configured to shut-down the system until the fault is cleared by enabling/disabling the electrical energy source 218.

The temperature measurement of the electrical energy source 218 can be used by the BMS 222 for estimations, as safety limits for over temperature, and cold temperature charging limits to prevent lithium plating. The BMS 222 can also be configured to perform cell group level balancing to maximize the performance of the mobile power unit 200.

Battery charging can be controlled with an on-board battery charger 224. As shown, the on-board battery charger 224 can be electrically coupled to both the PDU 220 and the electrical energy source 218 via the BMS 222. The battery charger 224 is connected to/fused within the PDU 220 in case there is a short circuit. The battery charger 224 can be air or liquid cooled and can be configured to regulate itself (i.e., if an over-temperature event were to occur the battery charger can automatically shut-down). The battery charger 224 can communicate with the BMS 222 to regulate the charge current and ensure no cells in the electrical energy source are over-charged.

The mobile power unit 200 can be configured to utilize existing electric vehicle charging infrastructure and components (the Combined Charging System, or CCS) to charge its battery energy source 218. Therefore, an optional CCS controller 228 can facilitate charging on a CCS network via an AC power source or alternatively via an off-board DC fast charger. The CCS controller 228 can be coupled to/configured to communicate with the BMS 222 and an electrical connector 206c to control the AC and/or DC charging of the electrical energy source 218 on the CCS network.

Charging of the electrical energy source 218 from external power sources can be accomplished via a connector 206c on an interface panel of the mobile power unit. For example, the connector 206c can be a SAE J1772 connector that, in turn, can be connected to an external power source to charge the mobile power unit 200. It should be understood that other electrical connector types can be used for charging the mobile power unit 200.

The mobile power unit 200 can further include an overall system controller or electronic control unit (ECU) 226 which can configure/control the overall operation of the mobile power unit. In some embodiments, the controller can be integrated into the user interface or GUI described above. The system controller or ECU 226 can communicate with the other microcontrollers of the mobile power unit (such as the BMS 222, the CCS controller 228, etc.) via a Controller Area Network (CAN bus), for example. A low voltage DC/DC converter 230 can be used to regulate the voltage for the controllers and microcontrollers of the mobile power unit. For example, the low voltage DC/DC converter 230 can convert the high voltage from the electrical energy source 218 (e.g., 300-450V) to a much lower voltage (e.g., 12V) to operate various controllers and microcontrollers. The ECU 226 can monitor all functions and features of the mobile power unit 200, and can be configured to communicate information to a distribution center via wired or wireless communication. For example, the ECU 226 can monitor and communicate information relating to the mobile power unit 200 or electrical energy source 218, such state of charge, state of health, temperature, etc. to a remote location.

The mobile power unit 200 can further include a high voltage DC/DC converter 230 electrically coupled to the PDU 220. The high voltage DC/DC converter 230 can be configurable to operate in a plurality of different modes. In one specific embodiment, the high voltage DC/DC converter 230 can operate in two distinct configurations. For example, in a first configuration, the high voltage DC/DC converter 230 can operate as a boost converter in which it is configured to boost an unregulated electrical energy source voltage 218 (e.g., an unregulated battery voltage of 300-450V) up to an elevated DC voltage that is regulated (e.g., such as up to a regulated 750-850V DC). Similarly, if the unregulated battery energy source 218 voltage is lower than it should be (e.g., the expected voltage is at least 325V, but the actual voltage is lower), then the high voltage DC/DC converter 230 could be configured to increase the voltage of the electrical energy source 218 to the expected source voltage. In some embodiments, the high voltage DC/DC converter 230 can be configured to slowly ramp-up from the battery voltage to the higher voltage to avoid hard starting the system (e.g., the mobile power unit 200). In a second configuration, the high voltage DC/DC converter 230 can operate as a pass-through, in which the output voltage of the high voltage DC/DC converter 230 is the same as the electrical energy source 218 voltage (e.g., an unregulated 300-450V). In other embodiments, it may be desirable to reduce the unregulated battery energy source voltage to a reduced DC voltage. For example, some embodiments of the mobile power unit 200 can include an energy source with a source voltage of up to 1000V. In these implementations, it would therefore be necessary for the high voltage DC/DC converter 230 to reduce the source voltage down to 300-450V for use within the mobile power unit 200. In these embodiments, the high voltage DC/DC converter 230 could be or operate as, for example, a buck converter.

The mobile power unit 200 can further comprise one or more inverter stages, or alternatively, a multi-stage inverter, electrically coupled to the output of the high voltage DC/DC converter 230. Example inverter stages are illustrated as inverter stages 232a-232d in FIG. 2. However, persons skill in the art will appreciate that any number of inverter stages can be implemented depending on the desired output of the mobile power unit 200. In some embodiments, the inverter stages can utilize the same hardware (or similar hardware) as the high voltage DC/DC converter 230, but can instead be controlled differently through specific CAN bus commands from the ECU 226. In other embodiments, the inverter stages can implement different electrical topologies than illustrated/described herein. Each inverter stage has a DC input from the high voltage DC/DC converter 230 and is configured to create an AC output utilizing 3-phases. In one specific implementation, each phase can support a current of 32A for a total current of 96A peak per phase (e.g., if the inverter stages are operated in parallel as a single phase). According to the present disclosure, the ECU 226 is configured to combine the plurality of inverter stages at various phase shifts to create 3-phase and split-phase outputs, which are passed to the interface panel and the electrical connections as described above. AC and/or DC outputs from any of the inverter stages 232a-232d may be provided to output panel 202.

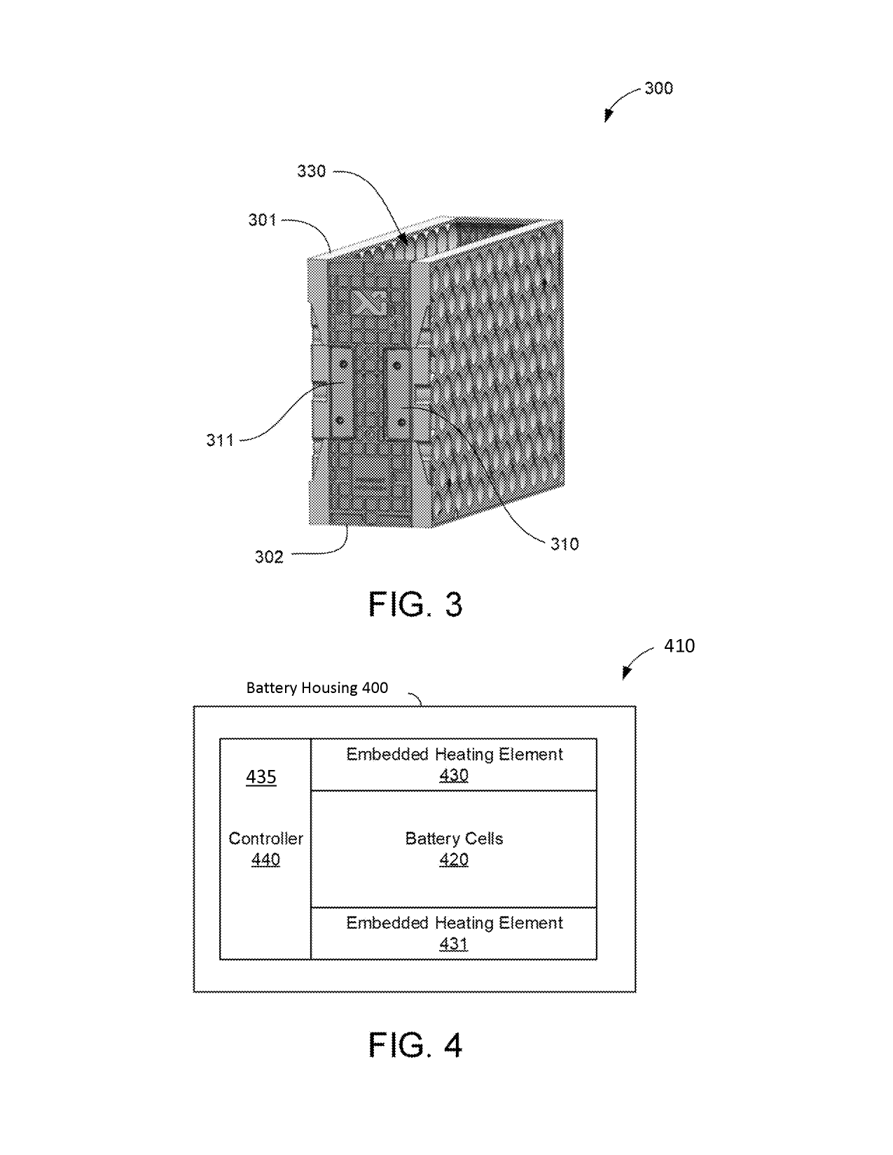

FIG. 3 shows an isometric view of an example battery housing 300. The battery housing 300 can be used to house, protect, and mount any feasible battery cell within a mobile power unit (such as the mobile power unit 200 of FIG. 2). In some examples, the battery housing 300 may be used to affix one or more batteries (battery cells) with respect to the electrical energy source 218. In some embodiments, the electrical energy source 218 comprise a plurality of battery housings 300, each housing including a plurality of battery cells. Therefore, the mobile power units described herein can include a plurality of these battery housings (and associated battery cells) to provide very large energy capacities as high as 500kWh-1,000kWh or more. As used herein, the terms battery and battery cells are interchangeable and can describe any feasible energy storage unit, device, or the like. Battery cells may occupy region 330 and generally have the shape of a rectangular prism. The battery housing 300 may include a sleeve 301 that partially or completely surrounds, and is securely attached to, the battery cells (battery cells not shown). In some variations, the sleeve 301 may surround four sides of the battery. The electrical energy source 218 can include any number of batteries that are interconnected in a parallel and/or serial fashion to provide an input voltage to the PDU 220 and the high voltage DC/DC converter 230. The sleeve 301 can be formed from heat-resistant plastic, extruded or machined metals, or a combination of any of these materials. The sleeve 301 can include multiple battery terminals disposed on an external surface that enable electrical connection to the enclosed battery. For example, the sleeve 301 can include a first (e.g., a positive) terminal 310 and a second (e.g., negative) terminal 311 on a front surface 302. Although only two terminals are shown here, in other embodiments, the battery housing 300 may include any number of battery terminals.

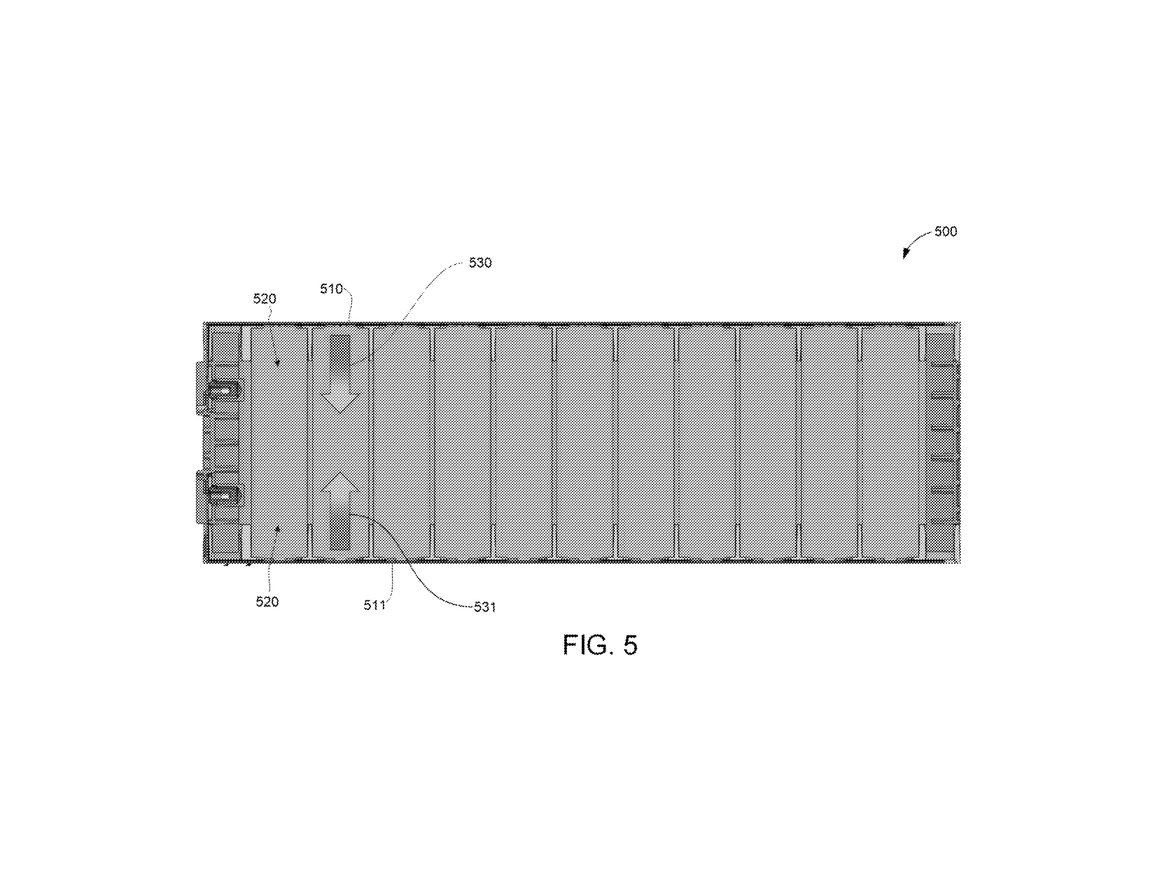

The battery housing 300 can include a number of battery cells and two or more embedded heating elements. The arrangement of the battery cells and the heating elements is described in more detail with respect to FIGS. 4-5.

FIG. 4 is simplified block diagram of a battery temperature control system 410. The battery temperature control system 410 can include a battery housing 400, battery cells 420, a first embedded heating element 430, a second embedded heating element 431, and a controller 440. Although only two embedded heating elements are shown here, in other embodiments, the battery temperature control system 400 can include any number of embedded heating elements, including less than two heating elements or more than two heating elements.

Battery efficiency can be defined as a ratio of energy (or charge) retrieved or provided by a battery to the energy (or charge) put into the battery. Generally, environmental temperatures can adversely affect battery efficiency by reducing the amount of available energy as temperature decreases. This temperature/efficiency relationship can adversely affect operation of the battery temperature control system 410 during, for example, cold weather. To increase battery efficiency, the first and second embedded heating elements 430 and 431 can be configured to increase temperatures around the battery cells 420, particularly when operating the battery temperature control system 410 when the environmental temperatures in or around the battery housing 400 fall below a threshold temperature. In some variations, the battery temperature control system 410 can be configured to maintain any temperature of the battery cells and/or battery housing, including a minimum operating temperature. The first and second embedded heating elements 430 and 431 can be powered by an internal power source (e.g., battery cells 420) or an external power source (e.g., separate from the battery cells 420).

In some embodiments, the temperature of the battery cells can be increased when a load is applied to the battery cells (e.g., a load is connected to the mobile power unit). Controlling the battery temperatures to be within a desired temperature range can improve efficiency and/or performance when a load is applied to the cells. In some cases, the temperature of the battery may be increased when the battery cells are charging to help reduce charging times (e.g., when the mobile power unit is charged). Elevated battery temperatures can condition the battery cells to recharge faster compared to recharging at lower temperatures.

The battery cells 420 can include any one or more feasible energy storage devices. For example, the battery cells 420 can include any of the energy storage devices described herein, including lithium-ion battery cells.

The first embedded heating element 430 can be disposed adjacent to one side of the battery cells 420 while the second embedded heating element 431 can be disposed on a second, and in some cases opposing (e.g., opposite to and across from), side of the battery cells 420. Thus, the embedded heating elements 430 and 431 can provide heat to two different sides or regions of the battery cells 420.

The controller 440 can control operation of the first embedded heating element 430 and the second embedded heating element 431. The controller 440 can include, for example, one or more processors and associated circuitry configured to control operation of the heating elements. In some cases, the controller 440 can include or be electrically coupled to one or more temperature sensors 435 configured to sense or measure a temperature of the battery cells, or alternatively, a temperature of the ambient environment around the battery cells, inside the housing, and/or outside the housing, depending on the location of the temperature sensors. In various embodiments herein, the temperature sensors may be disposed on or in the housing, on or in the heating elements, or on or in the battery cells themselves. Additionally, as described above, the BMS 222 includes functionality configured to monitory the state of the battery cells including temperature.

The temperature sensors 435 can enable, at least in part, heating of the first embedded heating element 430 and the second embedded heating element 431 when a sensed temperature falls below a temperature threshold. In some examples, the controller 440 can regulate an environmental temperature within the battery housing by operating the first embedded heating element 430 and the second embedded heating element 431. In addition, the controller 440 may receive an “enable” or “disable” signal from another control unit, or the like. The enable/disable signal can be used in conjunction with the temperature sensor to control operation of the embedded heating elements. For example, the state of the enable/disable signal as well as the detected temperature can determine when the first embedded heating element 430 and the second embedded heating element 431 turns on to provide heat to the battery cells 420. In this manner, operation of the heating elements may be restricted or prevented by a particular state of the enable/disable signal. Thus, the enable/disable signal can prevent unintentional operation of the first embedded heating element 430 and the second embedded heating element 431 during periods when the mobile power unit 100 of FIG. 1 and/or the battery temperature control system 400 is not in use.

For example, as a baseline when the mobile power unit is not in use or being charged, the controller 440 may receive a “disable” signal from another control unit of the mobile power unit. Alternatively, the mobile power unit may initially default to a “disable” status for the embedded heating elements. When the “disable” status is active, the controller 440 will not activate or control the embedded heating elements to heat the battery cells, even if the temperature of the cells or the battery housing environment is below the temperature threshold. However, any number of actions can trigger the controller to receive an “enable” signal from another control unit of the mobile power unit, including but not limited to charging of the battery cells or connecting a load to the mobile power unit. For example, if the mobile power unit is plugged in for charging of the battery cells, or if a load is connected to the mobile power unit, the BMS, ECU, or any other control unit of the mobile power unit may send an “enable” signal to the controller 440 to activate the embedded heating units if the ambient or environmental temperature of the cells or housing falls below the threshold temperature. The “enable” status can remain active in the mobile power unit until the load is removed or charging is stopped.

In some variations, power for the controller 440, the first embedded heating element 430, and the second embedded heating element 431 may be provided by the battery cells 420.

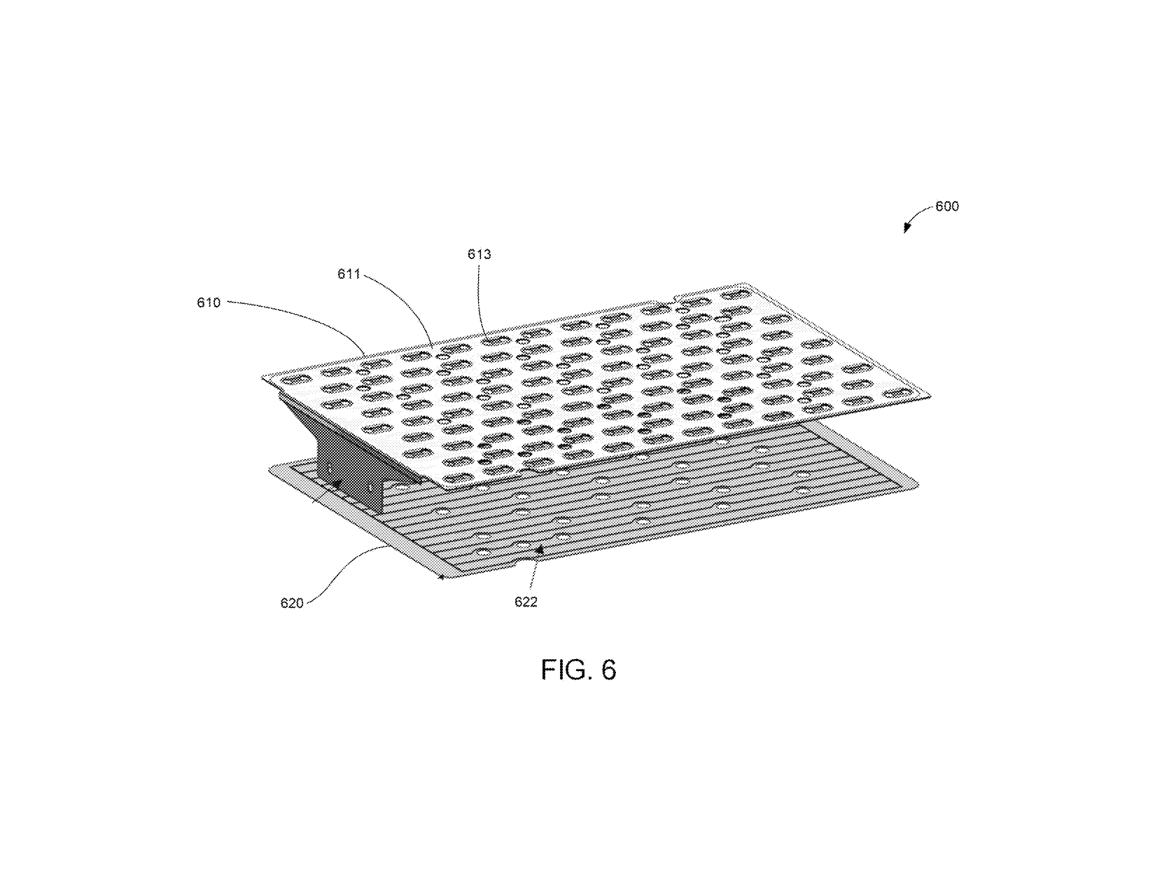

In some embodiments, the functionality of the controller 440 may be combined with the first embedded heating element 430 and the second embedded heating element 431. For example, an embedded heating element may be implemented with a positive temperature coefficient (PTC) material. As described below in conjunction with FIG. 6, PTC material can enable the embedded heating elements to self-regulate temperature, eliminating the need for a separate controller 440.

In some examples, the embedded heating elements 430 and 431 may be embedded with current collectors that are used to convey battery charge to and from the battery cells 420. Example embodiments are described below with respect to FIGS. 5-8.

FIG. 5 shows an example cross-sectional view of a battery temperature control system 500. The battery temperature control system 500, which is an example of the battery temperature control system 410 of FIG. 4, can include a first conductor assembly 510, a second conductor assembly 511, and battery cells 520. Each conductor assembly can include components that couple to the battery cells 520 to transport energy (voltage, current) to and from the battery cells 520. The first and second conductor assemblies 510 and 511 may also include an embedded heating element (not shown for clarity).

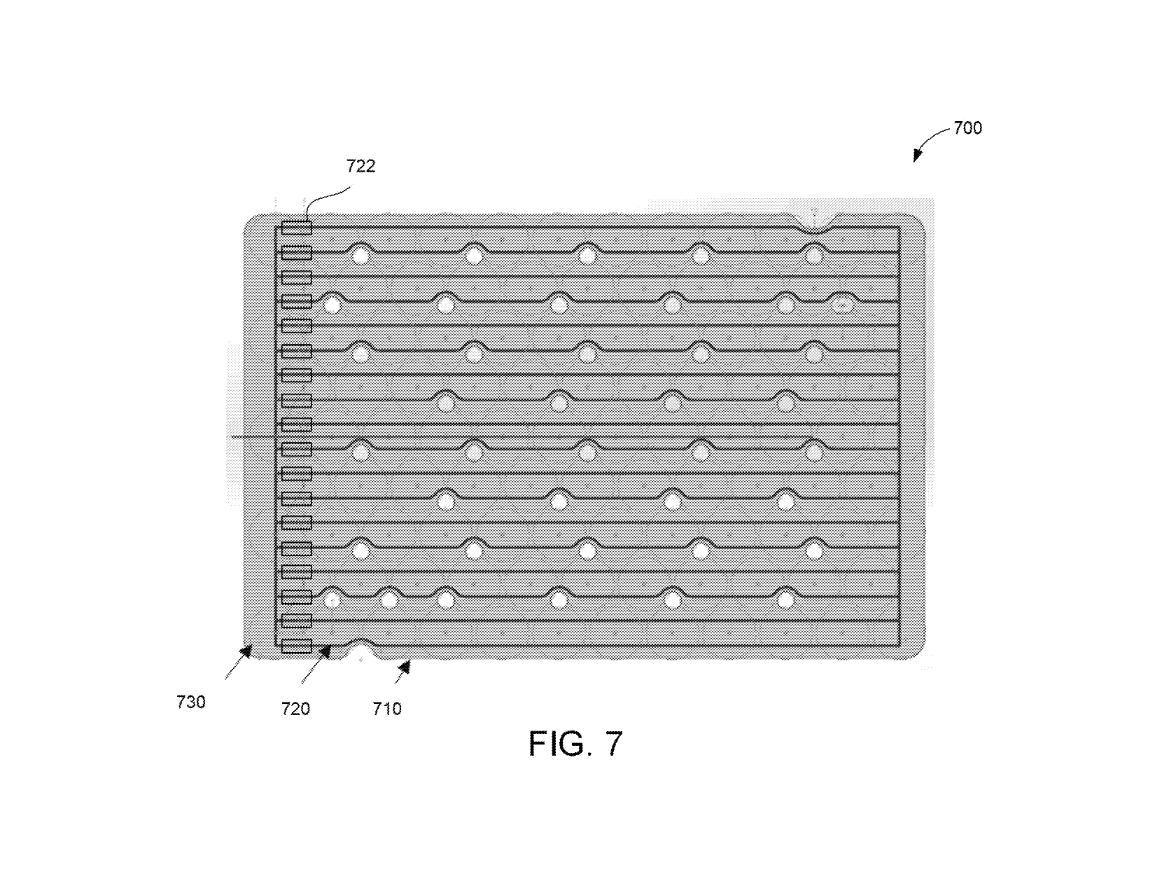

The first conductor assembly 510 may be disposed on one side of the battery cells 520 while the second conductor assembly 511 may be disposed on an opposite or opposing side of the battery cells 520. Through this configuration, heat from the embedded heating elements in the conductor assemblies can be introduced through two sides of the battery cells 520. For example, the first conductor assembly 510 can provide heat in a first direction 530 and the second conductor assembly 511 can provide heat in a second (generally opposite) direction 531. Thus, heat can advantageously be delivered through two sides of the battery cells 520 and therefore warm the middle of the battery cells 520 faster than delivering heat through only one side of the battery cells 520. In some examples, the first conductor assembly 510 and the second conductor assembly 511 can advantageously reduce parts count, simplify wiring, and reduce manufacturing costs. In some variations, the first conductor assembly 510 and/or the second conductor assembly 520 can be installed during an assembly process. Example conductor assemblies are described below with respect to FIGS. 6-7. In some implementations, the battery temperature control system 500 can significantly or completely eliminate the need for an external thermal management system.

FIG. 6 depicts an exploded view of an example conductor assembly 600. Although only one conductor assembly 600 is shown here, a battery system can include any feasible number of conductor assemblies. The conductor assembly 600, which can be an example of the first conductor assembly 510 or the second conductor assembly 511 of FIG. 5, can include a current collector 610 and an embedded heating element assembly 620. Although shown separated here for explanation, when assembled the current collector 610 and the embedded heating element assembly 620 may be tightly coupled or connected to each other. Alternatively, the heating element assembly may be integral to the current collector. The current collector 610 can be configured to carry current to or away from any number of battery cells (not shown). In some examples, the current collector 610 may also electrically and/or mechanically couple one or more battery cells together. The embedded heating element assembly 620 can be configured to provide heat to nearby battery cells as described above.

In some examples, the conductor assembly 600 can be a lamination or combination of a first layer that includes the current collector 610 and a second layer that includes the embedded heating element assembly 620. The layers of the conductor assembly 600 can be arranged such that the second layer (the embedded heating element assembly 620) is closer or more proximate to the battery cells compared to the first layer (the first current collector 611). In other words, the embedded heating element assembly 610 may be disposed between the current collector 610 and any battery cells. In this manner, heat from the embedded heating element assembly 620 is more efficiently delivered to the battery cells. That is, heat from the embedded heating element assembly 620 does not radiate or conduct through the current collector 610 before reaching the battery cells.

In some variations, the current collector 610 can include battery cell contacts and current conducting elements. For example, the current collector 610 can include a plurality of contacts 613 that are electrically connected to one or more cells of the battery cells. The current conducting elements can be configured to connect together multiple individual battery cells. Thus, the current conducting elements can connect two or more battery cells together in parallel or series.

As shown, the embedded heating element assembly 620 may include one or more heating elements 622 that traverse the embedded heating element assembly. In some variations, the heating elements 622 may include a resistive layer that emits or radiates heat in response to a received current. In some cases, the resistive layer may include, or be formed with a PTC ink or foil. A PTC ink or foil may have a resistance that increases as temperature increases. For example, as a PTC element conducts current and radiates heat, its resistance increases, thereby reducing current drawn by the PTC element. The reduced current, in turn, reduces radiated heat. In some variations, the embedded heating element can self-regulate temperature, particularly when the embedded heating element includes a PTC element. In some examples, a PTC element can heat up until a threshold temperature is reached. This threshold temperature, sometimes called a switch-off temperature, can be selectable determined by the selected PTC element. After reaching or exceeding the threshold temperature, the PTC element can open up (become an open circuit) and stop conducting current.

FIG. 7 is a detailed view of an example embedded heating element assembly 700. The embedded heating element assembly 700 may be another example of the embedded heating element assembly 620 of FIG. 6. The embedded heating element assembly 700 may include a substrate 710 and one or more heating elements 720. The heating elements 720 may be another example of the heating elements 622.

The substrate 710 can be a rigid, semi-rigid, or conformable material. In some cases, the substrate 710 can be a flexible or conformable polymer, an injection molded part that may be combined with a battery housing or case, or any other feasible surface.

The heating elements 720 can radiate heat in response to a supplied current. The heating elements 720 can be disposed on at least one side of the substrate 710. In some variations, the heating elements 720 may be arranged on the substrate 710 in a manner to radiate heat to individual battery cells 730 (shown in broken lines). For example, the heating elements 720 may be disposed on the substrate 710 to traverse from one edge to an opposite edge. In some examples, two heating elements 720 may be proximate to each battery cell 730.

In some examples, the heating elements 720 may be disposed or positioned adjacent or next to one axial end of the battery cells 730, particularly when the battery cells 730 are generally cylindrical in shape. In some other examples, the heating elements 720 may be disposed or positioned adjacent or next to sides of the battery cells 730.

The heating elements 720 may be formed from any feasible material that radiates heat. Some example materials include aluminum-based heating elements, thick film-based heating elements, mica-based thick film heating elements, and the like. In some variations, the heating elements 720 may include resistive layer heating elements that emit or radiate heat in response to a received current. In some cases, the heating elements 720 may include PTC links 722. Example PTC links 722 can be formed with any feasible PTC ink or foil. Although shown biased to one side of the heating elements 720, the PTC links 722 may be disposed on any position of the heating elements 720. In some examples, the PTC links 722 can self-regulate the heating elements 720 to a predetermined temperature. In some variations, the PTC links 722 can heat up until a threshold temperature is reached. This threshold temperature, sometimes called a switch-off temperature, can be determined, at least in part, by PTC materials used in the PTC links 722.

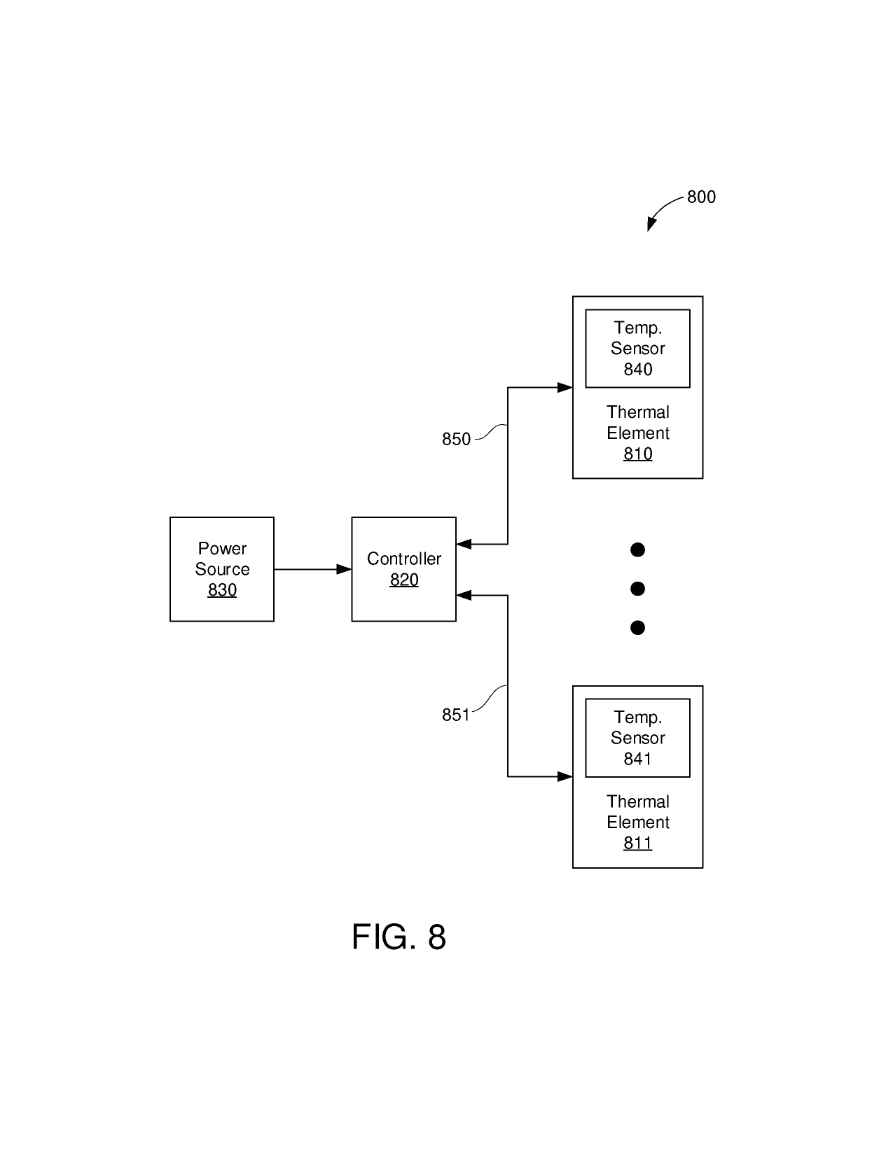

FIG. 8 is a block diagram of an example battery temperature control system 800. The battery temperature control system 800 can include a first thermal element 810, a second thermal element 811, a controller 820, and a power source 830. Although only two thermal elements 810 and 811 are shown, in other embodiments the battery temperature control system may include any number of thermal elements. The first thermal element 810 and the second thermal element 811 may be examples of the embedded heating element 620 of FIG. 6. In some examples, the first thermal element 810 may be associated with a first current collector assembly (such as the first current collector assembly 510 of FIG. 5) and the second thermal element 811 may be associated with a second current collector assembly (such as the second current collector assembly 511).

Each thermal element may include a temperature sensor. For example, the first thermal element 810 may include a first temperature sensor 840 and the second thermal element 811 can include a second temperature sensor 841. The temperature sensors may enable the associated thermal elements to regulate the temperature to a predetermined temperature. In some examples, the first temperature sensor 840 may sense a temperature local (nearby, adjacent, etc.) to the first thermal element 810. The temperature from the first temperature sensor 840 can directly or indirectly control the first thermal element 810. The second thermal element 811 and the second temperature sensor 841 may operate in a similar manner.

The controller 820 can control operation of the first thermal element 810 and the second thermal element 811. In some examples, the controller 820 can read or receive temperature measurements from the first temperature sensor 840 and the second temperature sensor 841. If the temperature measurements exceed a threshold temperature (for example, the measured temperature is lower than a threshold temperature), then the controller 820 can operate the first thermal element 810 and the second thermal element 811.

In some variations, temperature sensor functionality may be integrated with the thermal element. Returning to the example of thermal elements comprising PTC inks and foils, inherent PTC characteristics can enable the associated thermal elements to self-regulate temperatures, thereby acting as an integrated temperature sensor/heating element/controller combination. In those embodiments, functionality of the controller 820 and a temperature sensor (first or second temperature sensors 840, 841) can be integrated with a thermal element (first or second thermal elements 810, 811).

In some examples, the controller 820 can drive individual enable signals to control operations of the first thermal element 810 and the second thermal element 811. For example, the controller 820 can drive a first enable signal 850 coupled to the first thermal element 810 and a second enable signal 851 coupled to the second thermal element 811. In general, the enable signal can “enable” operations of the respective thermal element.

In some cases, the enable signal can work in conjunction with thermal sensors. For example, if an associated battery cell is not in use (e.g., not actively supplying power for another system such as the PDU 220 or DC/DC converters 230 of FIG. 2), then there is no need to heat the battery cells. In this case, the first enable signal 850 and the second enable signal 851 can be de-asserted to disable operation of the first thermal element 810 and the second thermal element 811, respectively. On the other hand, if the associated battery cell is being used, then the first enable signal 850 and the second enable signal 851 can be asserted to enable operation of the first thermal element 810 and the second thermal element 811. In some variations, the operation of the first thermal element 810 can be controlled by the first temperature sensor 840 while the operation of the second thermal element 811 can be controlled by the second temperature sensor 841. For example, when the temperature determined by the first temperature sensor 840 exceeds a threshold temperature and the first enable signal 850 is asserted, then the controller 820 can operate the first thermal element. Operation of the second thermal element 811 can be similar to the first thermal element 810.

In some variations, the first thermal element 810 and the second thermal element 811 can be operated to increase battery cell temperature to condition the battery cells for rapid charging. Operations may be similar to elevate battery cell temperatures for cold weather operation, but the desired or target temperature may be different.

Power for the first thermal element 810 and the second thermal element 811 may be provided directly or indirectly by the power source 830. In some embodiments, power for the first thermal element 810 and the second thermal element 811 may be provided through the controller 820. In some other embodiments, power for the controller 820, the first thermal element 810, and/or the second thermal element 811 may be provided by local battery cells. Thus, the power source 830 may be the battery cells heated by the nearby thermal elements.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being "on" another feature or element, it can be directly on the other feature or element or intervening features and/or elements may also be present. In contrast, when a feature or element is referred to as being "directly on" another feature or element, there are no intervening features or elements present. It will also be understood that, when a feature or element is referred to as being "connected", "attached" or "coupled" to another feature or element, it can be directly connected, attached, or coupled to the other feature or element or intervening features or elements may be present. In contrast, when a feature or element is referred to as being "directly connected", "directly attached" or "directly coupled" to another feature or element, there are no intervening features or elements present. Although described or shown with respect to one embodiment, the features and elements so described or shown can apply to other embodiments. It will also be appreciated by those of skill in the art that references to a structure or feature that is disposed "adjacent" another feature may have portions that overlap or underlie the adjacent feature.

Terminology used herein is for the purpose of describing particular embodiments only and is not intended to be limiting of the invention. For example, as used herein, the singular forms "a", "an" and "the" are intended to include the plural forms as well, unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof. As used herein, the term "and/or" includes any and all combinations of one or more of the associated listed items and may be abbreviated as "/".

Spatially relative terms, such as "under", "below", "lower", "over", "upper" and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as "under" or "beneath" other elements or features would then be oriented "over" the other elements or features. Thus, the exemplary term "under" can encompass both an orientation of over and under. The device may be otherwise oriented (rotated 90 degrees or at other orientations) and the spatially relative descriptors used herein interpreted accordingly. Similarly, the terms "upwardly", "downwardly", "vertical", "horizontal" and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise,” and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components, or sub-steps.

As used herein in the specification and claims, including as used in the examples and unless otherwise expressly specified, all numbers may be read as if prefaced by the word "about" or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value unless the context indicates otherwise. For example, if the value "10" is disclosed, then "about 10" is also disclosed. Any numerical range recited herein is intended to include all sub-ranges subsumed therein. It is also understood that when a value is disclosed that "less than or equal to" the value, "greater than or equal to the value" and possible ranges between values are also disclosed, as appropriately understood by the skilled artisan. For example, if the value "X" is disclosed the "less than or equal to X" as well as "greater than or equal to X" (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A battery housing comprising:
a first conductor assembly disposed proximate to a first side of a plurality of battery cells, the first conductor assembly comprising:
a first current collector configured to electrically couple together two or more battery terminals on the first side of the plurality of battery cells; and
a first embedded heating element configured to deliver heat to the first side of the plurality of battery cells; and
a second conductor assembly disposed proximate to a second side of the plurality of battery cells, the second conductor assembly including:
a second current collector configured to electrically couple together two or more battery terminals on the second side of the plurality of battery cells; and
a second embedded heating element configured to deliver heat to the second side of the battery cell.

2. The battery housing of claim 1, wherein the first embedded heating element and the second embedded heating element include a positive temperature coefficient (PTC) heating element.

3. The battery housing of claim 2, wherein the PTC heating element comprises at least one of a PTC ink and a PTC foil.

4. The battery housing of claim 2, wherein the PTC heating element regulates an operating temperature of at least one of the first embedded heating element and the second embedded heating element.

5. The battery housing of claim 1, wherein the first embedded heating element and the second embedded heating element include a resistive layer configured to radiate heat.

6. The battery housing of claim 1, wherein the first embedded heating element and the second embedded heating element are configured to be powered by one or more of the battery cells.

7. The battery housing of claim 1, wherein the first embedded heating element is disposed on a first substrate separate from the first current collector and the second embedded heating element is disposed a on a second substate separate from the second current collector.

8. The battery housing of claim 1, wherein the first embedded heating element is disposed between the battery cells and the first current collector, and the second embedded heating element is disposed between the battery cells and the second current collector.

9. The battery housing of claim 1, wherein the first embedded heating element is further disposed adjacent to a first axial end of the plurality of battery cells and the second embedded heating element is further disposed adjacent to a second axial end of the plurality of battery cells.

10. The battery housing of claim 1, wherein the first embedded heating element and the second embedded heating element are operated in response to a temperature near at least one of the first embedded heating element and the second embedded heating element.

11. The battery housing of claim 10, wherein the first embedded heating element includes a temperature sensor configured to determine a temperature near the first embedded heating element.

12. The battery housing of claim 1, wherein the first embedded heating element and the second embedded heating element are configured to operate in response to an enable signal.

13. The battery housing of claim 1, wherein the first side of the plurality of battery cells is opposite to and across from the second side of the plurality of battery cells.

14. The battery housing of claim 1, further comprising a controller configured to operate the first embedded heating element and the second embedded heating element in response to a temperature near at least one of the first embedded heating element and the second embedded heating element.

15. A battery temperature control system comprising:
a battery housing comprising:
a first conductor assembly disposed proximate to a first side of a plurality of battery cells, the first conductor assembly comprising:
a first current collector configured to electrically couple together two or more battery terminals on the first side of the plurality of battery cells; and
a first embedded heating element configured to deliver heat to the first side of the plurality of battery cells; and
a second conductor assembly disposed proximate to a second side of the plurality of battery cells, the second conductor assembly including:
a second current collector configured to electrically couple together two or more battery terminals on the second side of the plurality of battery cells; and
a second embedded heating element configured to deliver heat to the second side of the battery cells; and
a controller configured to operate the first embedded heating element and the second embedded heating element based at least in part on a temperature near at least one of the first embedded heating element and the second embedded heating element.

16. The battery temperature control system of claim 15, wherein the first embedded heating element includes a temperature sensor configured to determine a temperature near the first embedded heating element.

17. The battery temperature control system of claim 15, wherein the first embedded heating element and the second embedded heating element include a positive temperature coefficient (PTC) heating element.

18. The battery temperature control system of claim 17, wherein the PTC heating element comprises at least one of a PTC ink and a PTC foil.

19. The battery temperature control system of claim 17, wherein the PTC heating element regulates an operating temperature of at least one of the first embedded heating element and the second embedded heating element.

20. The battery temperature control system of claim 15, wherein the first embedded heating element is disposed between the battery cells and the first current collector, and the second embedded heating element is disposed between the battery cells and the second current collector.
